(19) United States
(12) Patent Application Publication
(10) Pub. No.: US 2005/0236100 A1
(43) Pub. Date: Oct. 27, 2005

(54) Method of making sheet with removable decorative articles

(75) Inventor: Setsuo Arisawa, Nitta-gun (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: YUBI INC., Nitta-gun (JP)

(21) Appl. No.: 10/838,498

(22) Filed: May 4, 2004

(30) Foreign Application Priority Data
Apr. 21, 2004 (JP) 2003-129806

(51) Int. Cl. B32B 33/00; B32B 9/00

(52) U.S. Cl. 156/290; 428/42.3; 156/79

(57) ABSTRACT

The invention relates to a method of making a sheet with one or more removable decorative articles thereon. The method comprises the steps of: providing a sheet having at least one release surface; applying an adhesive on the release surface to form an adhesive layer on the release surface of the sheet; applying a printing paste on the adhesive layer to form a decorative layer; and heating the decorative layer. The decorative layer has one or more extending portions being free of the adhesive layer and in contact with the release surface. The printing paste comprises a foaming agent. By heating, the one or more extending portions of decorative layers are three-dimensionally deformed.

### FIELD OF THE INVENTION

The invention relates to a sheet with one or more removable decorative articles thereon and a method of making the same. In non-limiting applications of the decorative article of the present invention, the decorative article is suitable for use as nail art for decorating fingernails or false nails, and jewelry tattoos for decorating human body such as cheek, arms, and shoulders. However, applications of the decorative articles of present invention are not limited to nail art or jewelry tattoo but also includes decorative articles for cellular phones, bags, notebooks, and the like.

### BACKGROUND OF THE INVENTION

In recent years, nail art has become popular and hand-painted nail art is probably the most common as nail art. One alternative to hand-painted nail art is to use decorative articles such as a nail sticker to decorate fingernails. However, the decorative articles of the prior art lack artistic appearance because they are in the form of transfer sheet and have only a flat appearance. There is a continuing need to improve artistic appearance of the decorative article, especially for use in decorating human exterior including fingernails, fake nails, cheeks, arms, shoulders and the like.

An object of the present invention is to apply a three-dimensional appearance to a decorative article.

### SUMMARY OF THE INVENTION

The present invention provides a method of making a sheet with one or more removable decorative articles thereon. The method comprises the following steps. A sheet having at least one release surface is provided. An adhesive layer is provided on the release surface of the sheet. One or more decorative layers or body layers are provided on the adhesive layer in which the one or more decorative layers have one or more adhesive-free portions being free of the adhesive layer. At least one of said one or more adhesive-free portions is in contact with the release surface of the release sheet. For example, in case of multi-layered decorative layers, a lower adhesive-free portion may be in contact with the release surface and an upper adhesive-free portion may be in contact with the lower adhesive-free portion. Depending on their areas and shapes, an upper adhesive-free portion may be in contact with the release surface. The one or more decorative layers comprise a foaming agent. It is not necessary to include the foaming agent entirely in the decorative layers. In one example, the foaming agent is included in a portion or portions comprising the one or more adhesive-free portion. The one or more decorative layers are treated by heat. By heating, the portion or portions being in contact with the release surface are released from the release surface and the one or more adhesive-free portions are three-dimensionally deformed. A sheet provided with one or more decorative articles thereon is obtained in which each article comprises the one or more decorative layers and the adhesive layer and is removably mounted on the release surface of the sheet via the adhesive layer.

The present invention also provides a sheet with one or more removable decorative articles thereon, and the decorative article comprises an adhesive layer and one or more decorative layers. The sheet with one or more decorative articles includes a sheet having at least one release surface; an adhesive layer formed on the release surface of the sheet; and at least one decorative layer formed on the adhesive layer, the decorative layer having one or more adhesive-free portions or extending portions being free of the adhesive layer. At least one or more portions of the decorative layer is formed from a material comprising a foaming agent. The adhesive-free portions or one or more extending portions are three-dimensionally deformed by heat treatment. The one or more decorative articles are removably mounted on the release surface of the sheet.

Preferably, the layers are formed by silk screen printing or screen printing.

In one aspect of the invention, the method comprises the steps of: providing a sheet having at least one release surface; applying an adhesive on the release surface to form an adhesive layer on the release surface of the sheet; applying a printing paste on the adhesive layer to form one or more decorative layers or body layers, and heating the one or more decorative the decorative layers. The decorative layers, or body layers have one or more adhesive-free portions or extending portions being free of the adhesive layer and the adhesive-free portions or extending portions are in- contact with the release surface of the sheet. The printing paste comprises a foaming agent. By heating the one or more decorative layers, the one or more adhesive-free portions or extending portions are removed from the release surface and are deformed, thereby obtaining the sheet having one or more decorative articles with a three dimensional appearance.

In another aspect of the present invention, the decorative article comprises a buffer layer.

In one preferable aspect, the decorative layer has an area larger than an area of the adhesive layer. The adhesive-free portions or one or more extending portions are in contact with the release surface of the sheet prior to heating. The one or more adhesive-free portions or extending portions are released from the release surface and deformed when heated.

The decorative layer may be formed by a plurality of silk screen printing processes. In one aspect, all printing pastes include a foaming agent. In another aspect, some printing pastes include a foaming agent and the other printing pastes do not include a foaming agent.

A printing paste for body layer and buffer layer, if provided, may comprise water, waterborne resin, dye and/or pigment, a thickener, and a dry retardant. The waterborne resin may preferably be selected from the group consisting of urethane resin, acrylic resin, urethane-acrylic resin, silicone rubber material and any combinations thereof. The decorative article obtained from the printing paste comprising the waterborne resin and the like is flexible and suitably used for curved surfaces of fingernails or false nails, and for curved and variable surfaces of human skin.

### BRIEF DESCRIPTION OF THE DRAWINGS

FIG. 1 is a schematic view showing a sheet with a decorative article obtained after a printing process;

FIG. 2 is a schematic view showing a sheet with a decorative article obtained after a heating process;

FIG. 3 is a view similar to FIG. 1 but shows an embodiment of a sheet with a decorative article obtained after a printing process;

FIG. 4 is a view similar to FIG. 2 but shows an embodiment of a sheet with a decorative article obtained after a heating process;

FIG. 5 is a view similar to FIG. 4 but shows another embodiment of a sheet with a decorative article obtained after a heating process;

FIG. 6 is a schematic view showing still another embodiment of a sheet with a decorative article obtained after a heating process;

FIG. 7 shows an embodiment of a sheet with decorative articles thereon in which an upper view is a plan view thereof, a middle view is a side view thereof obtained after printing, and a lower view is a side view thereof obtained after heating;

FIG. 8 shows another embodiment of a sheet with a decorative article in which an upper view is a schematic view thereof obtained after printing, and a lower view is a schematic view thereof obtained after heating;

FIG. 9 explains the embodiment of FIG. 8 in which an upper view is a plan view of an adhesive layer provided on the sheet, a middle view is a plan view of a decorative layer on the sheet obtained after printing and prior to heating, and a lower view is an explanatory view showing positional relations between the adhesive layer and the decorative layer;

FIG. 10 is a plan view showing still another embodiment of a sheet with decorative articles thereon;

FIG. 11 shows a false nail with decorative articles thereon;

FIG. 12 is a plan view showing still another embodiment of a sheet with decorative articles thereon;

FIG. 13 shows the embodiment of FIG. 12 in which an upper view is a schematic view thereof obtained after printing, and a lower view is a schematic view thereof obtained after heating;

FIG. 14 shows explanatory views of adhering the decorative article of FIG. 13 to an object;

FIG. 15 shows three different types of sheets with upper decorative portions thereon;

FIG. 16 shows a sheet with lower decorative portions thereon;

FIG. 17 shows views showing combining the upper decorative portions and the lower decorative portions;

FIG. 18 shows sheets with multi-layered three-dimensional decorative articles thereon; and

FIG. 19 shows another embodiment of multi-layered decorative layers that is similar to the embodiment shown in FIG. 13 and FIG. 14.

### DETAILED DESCRIPTION OF THE PREFERRED EMBODIMENT

In one preferred aspect of the embodiment, silk screen printing or screen printing is used. The silk screen printing is disclosed in Japanese unexamined publication No. 2003-330369 and the disclosure is incorporated herein by reference.

The silk screen printing is carried out by using a frame assembly including a screen made of screen gauzes or screen fabric defining openings therein.

A printing paste is applied to an object surface by a squeegee that contacts the screen to force the printing paste through openings in the screen. The screen gauze may be made of silk, nylon, Tetoron™, stainless steel and the like. According to the silk screen printing, one screen corresponds to one color. To produce a multi-colored decorative article, a plurality of screens having different types of openings therein and a plurality of screen printing processes are required. It will be appreciated by those skilled in the art that each layer may be formed by repeating screen printing processes to obtain a desired thickness of the layer. It will also be appreciated by those skilled in the art that drying process including natural drying and/or heating may be provided between each screen printing process. In one preferable aspect, the decorative articles of the present invention are obtained by hand printing.

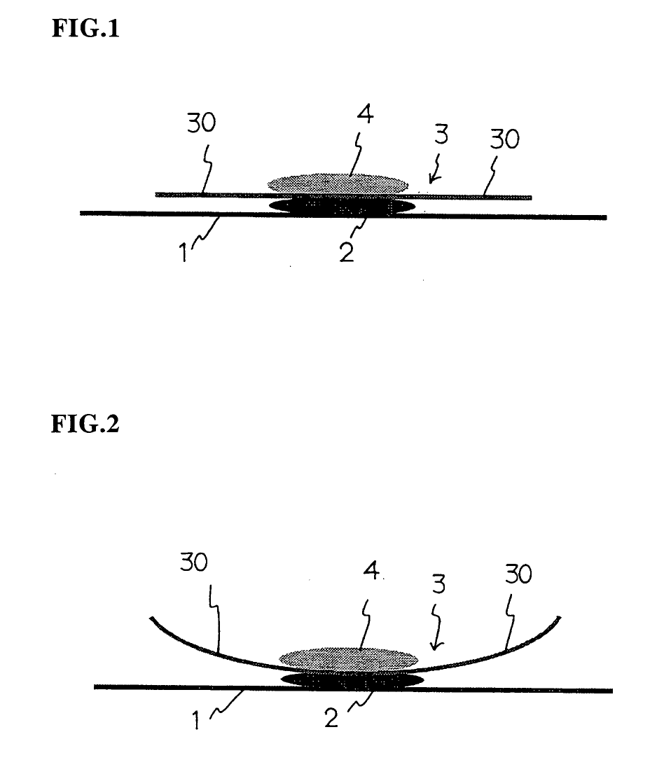

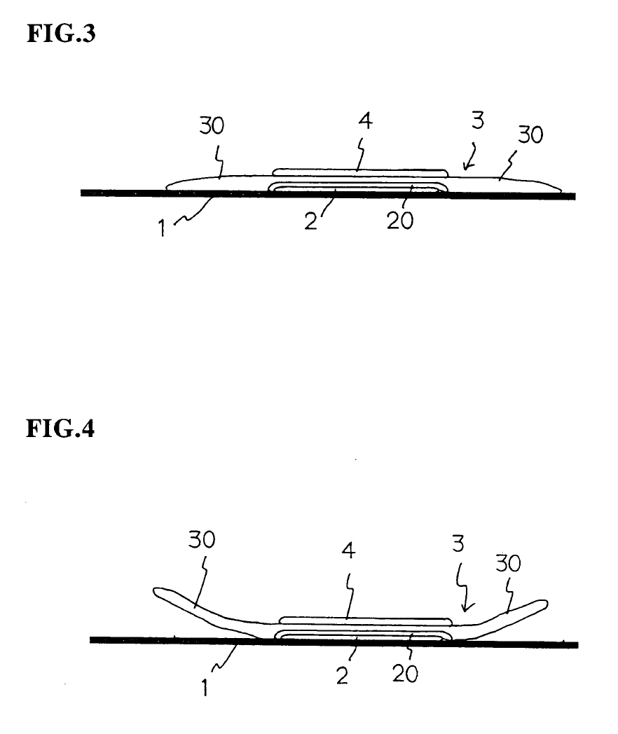

A method of making a sheet with removable decorative articles will be explained. FIGS. 1 and 2 are schematic views showing the concept of the present invention and FIGS. 3 and 4 are similar views but show an embodiment of the present invention. A release sheet 1 such as a transparent PET film or release paper is removably fixed on a printing table (not shown). At least one surface (an upper surface) of the release sheet 1 is coated with a release agent such as silicone or fluorocarbon polymers.

An adhesive is applied on the release sheet 1 by silk screen printing to form an adhesive layer 2 on the release surface of the release sheet 1. The adhesive layer 2 has an area smaller than an area of overall shape of decorative article. A screen (not shown) for the adhesive layer has predetermined openings therein so as to obtain desired adhesive layer by the screen printing. An area of the openings for the adhesive layer may be smaller than an area of openings for printing body layer.

The adhesive is preferably a pressure-sensitive adhesive and is effective at room temperature. When the decorative article is applied to human skin, an adhesive suitable for use as a medical adhesive tape is preferably used. Preferably, the adhesive is an acrylic adhesive but also includes an urethane adhesive or a silicone adhesive. In one non-limiting aspect, the adhesive layer has a thickness in the range of about 50 micrometers to about 400 micrometers, and more preferably between about 100 micrometers and about 200 micrometers.

As a second layer, a buffer layer 20 is applied on the adhesive layer 2 to cover an entire surface of the adhesive layer 2. The buffer layer 20 is formed by silk screen printing. A screen (not shown) for buffer layer has openings substantially identical to the openings for adhesive layer so as to overlays and covers the entire surface of the adhesive layer with the buffer layer 20.

One purpose of providing buffer layer 20 is to prevent the adhesive layer 2 from sticking to the screen gauze of the following screen printing and removing from the release surface of the release sheet 1 due to the stickiness of the adhesive layer 2.

A printing paste for buffer layer preferably comprises resin such as an urethane resin, an acrylic resin, an urethane-acrylic resin, a silicon rubber material, and any mixtures thereof. One preferable example, the paste for buffer layer has a viscosity that is equal to or smaller than a viscosity of paste for decorative layer. More preferably, the viscosity of the buffer layer paste is smaller. In one non-limiting aspect, the buffer layer has a thickness of 50 micrometers to 250 micrometers, and more preferably between 50 micrometers and 100 micrometers.

The buffer layer 20 is a preferable and very important element but is an optional element. Generally, the decorative layer is formed by a plurality of silk screen printing processes. For example, if a first application of printing paste for the decorative layer has an area larger than the area of adhesive layer, the first application seals the entire surface of the adhesive layer and the first application may function as a buffer layer as well.

Next, decorative layer 3 is formed on the buffer layer by silk screen printing. If the buffer layer is not used, the decorative layer 3 is directly formed on the adhesive layer 2.

As shown in FIGS. 1 thorough 6, the decorative layer 3 has an area larger than the areas of adhesive layer 2 and buffer layer 20 to define an extending portion 30 that is free of the adhesive layer 2. FIGS. 1 and 2 show the concept of the present invention but in embodiments, the extending portion 30 is in direct contact with the release surface of the release sheet 1 when applied as shown in FIG. 3.

The decorative layer 3 has a larger area than the area of adhesive layer 2 and the decorative layer 3 may be formed by using screen having openings, an area of which is larger than the opening area of the screen for adhesive layer 2. Alternatively, the decorative layer 3 may be formed by a plurality of silk screen printing processes to obtain a larger area. A printing paste for decorative layer may be similar to the paste that is used for conventional printing on fabric. The printing paste for decorative layer preferably comprises resin such as urethane resin, acrylic resin, urethane-acrylic resin, a silicon rubber material, and any mixtures thereof. Desirably, the printing paste comprises waterborne resin such as waterborne polyurethane.

The printing paste for decorative layer further comprises a foaming agent. In one non-limiting preferable example, the foaming agent is thermally expandable microcapsules (by Matsumoto Yushi Seiyaku K. K. for example).

Especially for the multi-colored decorative layer, the decorative layer may be obtained by a plurality of screen printing processes, i.e. by multiple applications of printing paste.

A top layer 4 may be formed on the decorative layer 3 by silk screen printing. The top layer 4 may have an area equal to or smaller than the area of the decorative layer 3. A printing paste for the top layer 4 may be similar to the paste for the decorative layer 3 and buffer layer 20. In one preferable aspect, the top layer 4 serves as a protection layer for the decorative layer 3.The printing paste for top layer may comprises solvent-resist polyurethane resin, particularly resisting acetone and the like. Application of top layer may be desired but optional. Alternatively, the top application of decorative layer may function as a top layer.

Next, heat is applied to the decorative article so as to deform the extending portion 30. By heat treatment, the extending portion 30 that is free of the adhesive layer 2 is released from the release surface of the release sheet 1 and deformed with the effect of the foaming agent. In one preferred example, the heat treatment process is operated at a temperature range from about 130 degree Celsius to about 150 degree Celsius for about 10 to 180 seconds. Non-limiting examples of heater includes a hot press, an infrared heater, a hand-held iron. The extending portion 30 can be deformed by heat treatment because the decorative layer 2 comprises foaming agent, and the extending portion 30 rests on the release surface of the release sheet 1 and is free of the adhesive layer 2. The extending portion 30 of the decorative layer 3 is not fixed with the adhesive layer 2 but deposited on the release surface so that the extending portion 30 can be removed from the release surface and deformed by heat treatment.

FIG. 6 shows an embodiment of multi-layered decorative articles after heat treatment in which each extending portion 30 of each decorative layer 3 is independently warped. Desirably, A release coating with a release agent such as silicone or fluorocarbon polymers is provided at least one of opposed surfaces of adjacent layers to prevent the adjacent layers from adhering together due to tackiness or stickiness when heated. The release coating may not be provided on a portion where the adhesive layer is presented. Alternatively, each layer may be made of different types of synthetic resins.

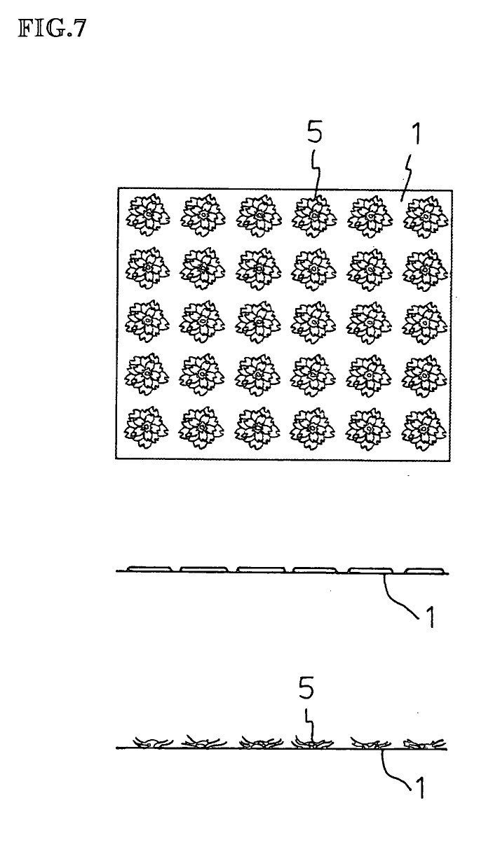

One preferable example of deformation is warping or bowing. The warped extending portion 30 can be used for resembling petals of flower, tree leaves, and wings of butterfly, for example. Therefore, the decorative article of the present invention can provide the three-dimensional appearances of a flower or butterfly, for example. FIG. 7 shows an example of a sheet of the present invention upon which a plurality of decorative articles 5 are removably mounted. The decorative articles of the FIG. 7 have the three-dimensional appearances of the flowers.

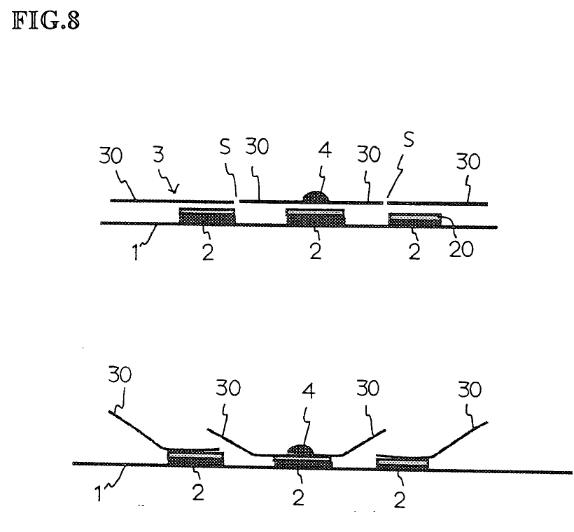

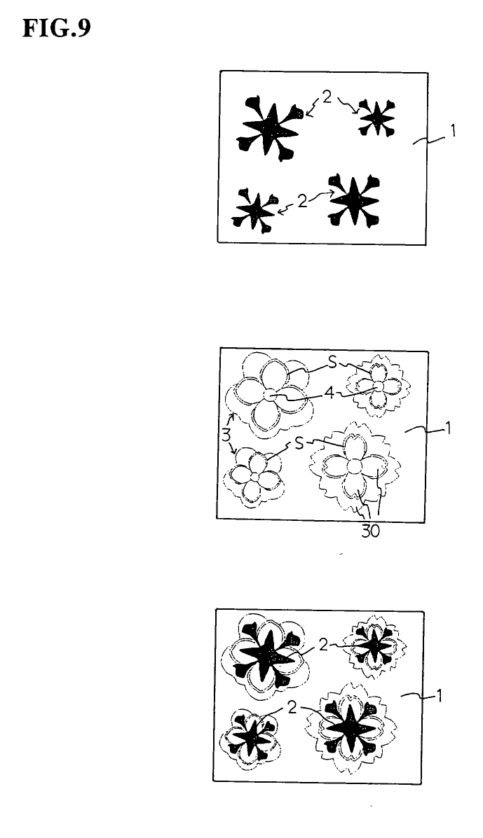

FIG. 8 and FIG. 9 show still another example of the present invention. A decorative layer 3 has one or more slits S therein and an adhesive-free portion 30 is provided at a portion in the vicinity of edge defining slit S. An adhesive layer 2 has a predetermined shape so as to provide one or more exposed areas of release surface of the sheet 1 corresponding to a portion or portions including the slit or slits S. FIG. 8 merely shows a concept of the embodiment and in fact the adhesive-free portions 30 are in contact with the exposed release surface when applied. When heated, the adhesive-free portions 30 remove from the exposed release surface and deform, and extend over a portion of an adjacent decorative layer 3.

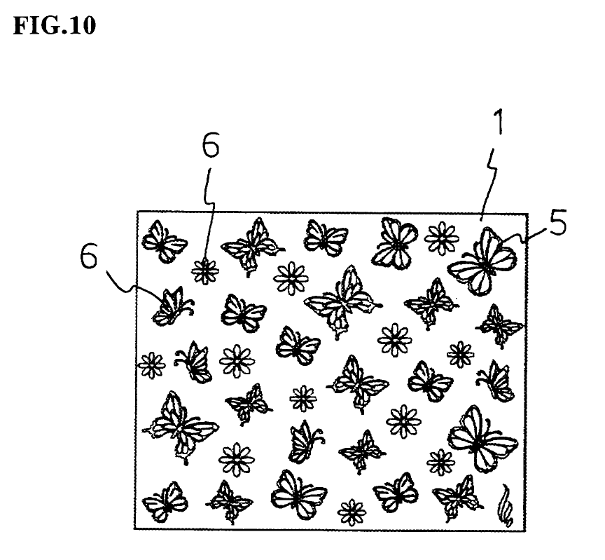

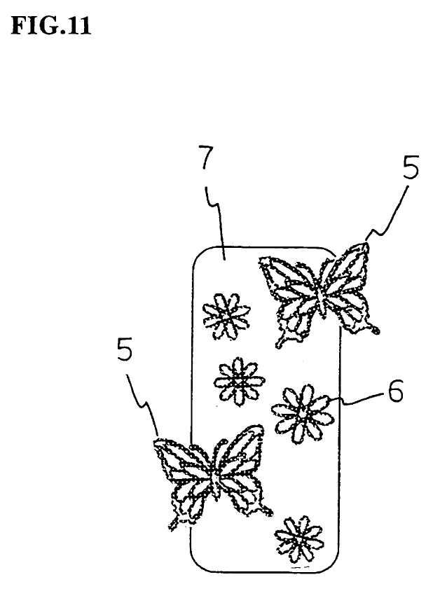

FIG. 10 shows still another example of a plan view of the sheet of the present invention upon which a plurality of decorative articles are removably mounted. The decorative articles of FIG. 9 include both the three-dimensional articles of butterflies 5 and flat articles 6. Preferably, the decorative articles are peeled off from the surface of the sheet with tweezers for adhering the decorative articles to an object. FIG. 11 shows a false nail 7 upon which both the three-dimensional articles 5 of butterfly and flat articles 6 are removably mounted.

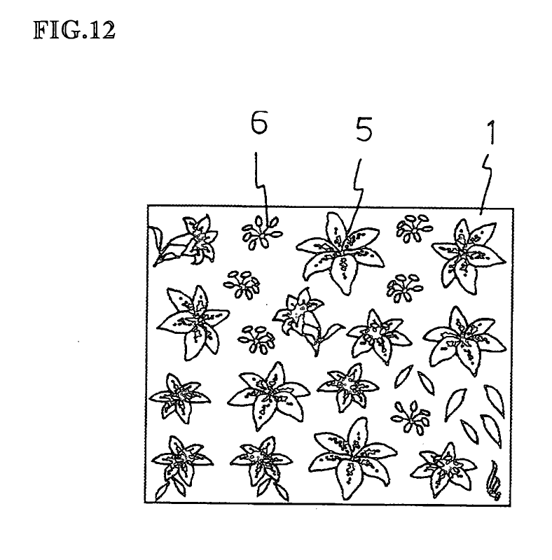

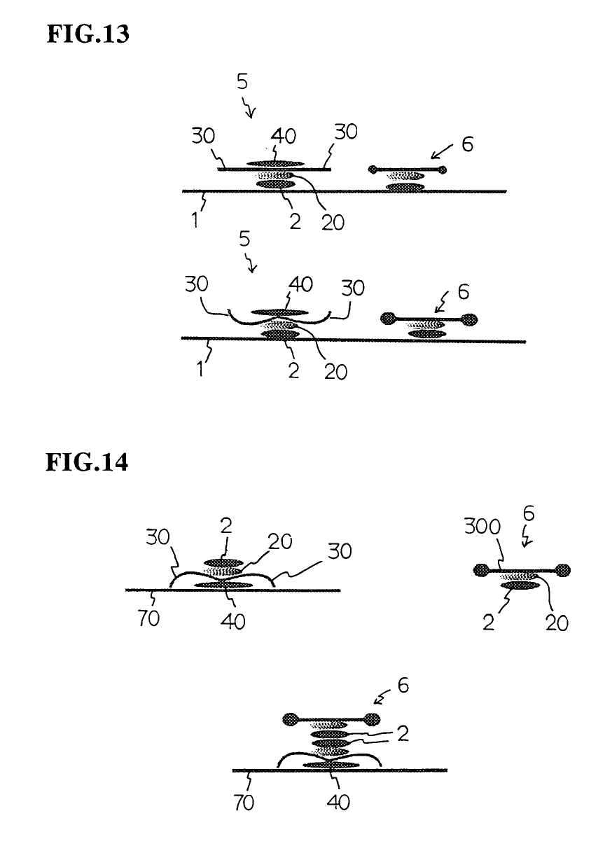

FIG. 12 shows still another example of a plan view of the sheet upon which a plurality of decorative articles are removably mounted. The decorative articles of FIG. 12 include both flat articles 6 and three-dimensional articles 5. A decorative layer 300 of the decorative layer 6 does not include a foaming agent in this embodiment. As shown in FIG. 13, another adhesive layer 40 is applied upon the decorative layer. After providing another adhesive layer 40, the decorative layer is deformed by heating. The three-dimensional decorative article is adhered to an object 70 such as fingernail, false nail, skin, and the like with another adhesive layer 40. The flat article 6 is adhered to the adhesive layer 2 of the three-dimensional article. Alternatively, a consumer may apply a coating on the adhesive layer 2 to negate an adverse effect of exposed adhesive layer 2.

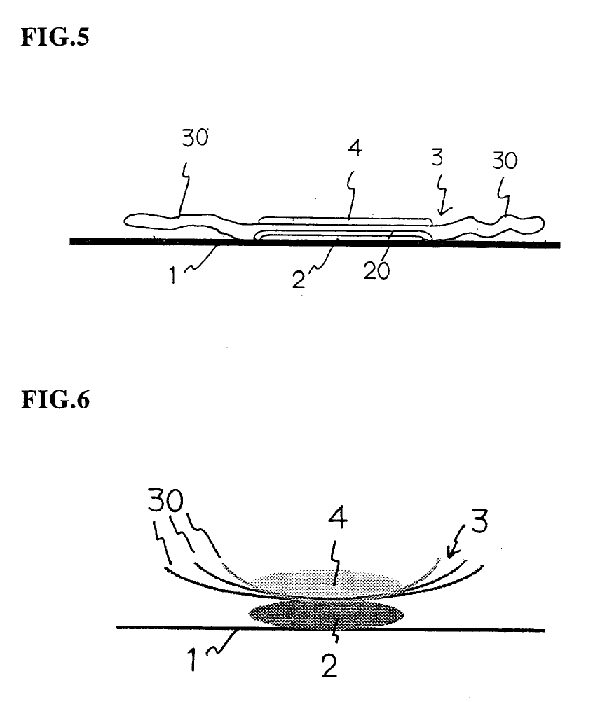

Deformation of adhesive-free portion or extending portion is not limited to warping or bowing. The deformation of extending portion may vary depending on shapes of extending portion of decorative layer, thickness of decorative layer, an area ratio of extending portion to adhesive layer, an area of top layer, a ratio of a foaming agent, and heat treatment condition, for example. Depending on conditions, the extending portion 30 may provide a three-dimensional appearance shown in FIG. 5. In any event, the adhesive-free portion or the extending portion being free of the adhesive layer may be deformed from a flat configuration to a three-dimensional configuration by heating, thereby applying a three-dimensional appearance to the decorative article.

According to the present invention, a sheet with removable decorative articles having an adhesive layer, an optional buffer layer, one or more decorative layers having one or more adhesive-free or extending portions with a three-dimensional appearance, and an optional top layer is obtained. The decorative article can be removed or peeled off from the release sheet and is preferably used for decorating fingernails or false nails, for example.

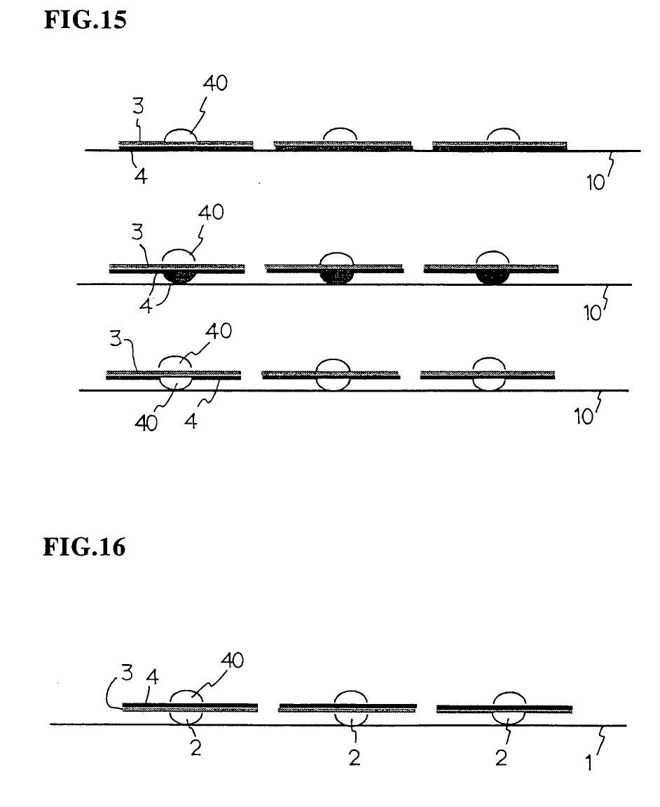

FIGS. 15 through 19 show embodiments for obtaining multi-layered decorative layers. FIG. 15 shows a release sheet 10 with an upper decorative portion thereon. In an upper view, a top layer 4 is provided on a release surface of the sheet 10, followed by providing a decorative layer 3 and followed by providing an adhesive layer 40 of a smaller area. In a middle view, a top layer 4 of a smaller area is provided on a release surface of the sheet 10, followed by providing a top layer 4 of a larger area, followed by providing a decorative layer 3 and followed by providing an adhesive layer 40. In a lower view, an adhesive layer 40 of a smaller area is provided on a release surface of the sheet 10, followed by providing a top layer 4 of larger area, followed by providing a decorative layer 3 and followed by providing an adhesive layer 40 of a smaller area. In the middle view and upper view, the top layer 4 is in face in contact with the release surface of the sheet 10. The upper adhesive layer 40 may comprise a pressure-sensitive adhesive or a hot melt adhesive. The upper decorative portion is preferably obtained by the screen printing process.

FIG. 16 shows a release sheet 1 with a lower decorative portion thereon in which an adhesive layer 2 of a smaller area is provided on a release surface of the sheet 1, followed by providing a decorative layer 3 of a larger area, top, followed by providing a top layer 4 and followed by providing an adhesive layer 40 of a smaller area. The decorative layer 3 is in contact with the release surface of the sheet 1. The adhesive layer 2 may comprise a pressure-sensitive adhesive. The adhesive layer 40 may comprise a pressure-sensitive adhesive or a hot melt adhesive. The lower decorative portion is preferably obtained by the screen printing process.

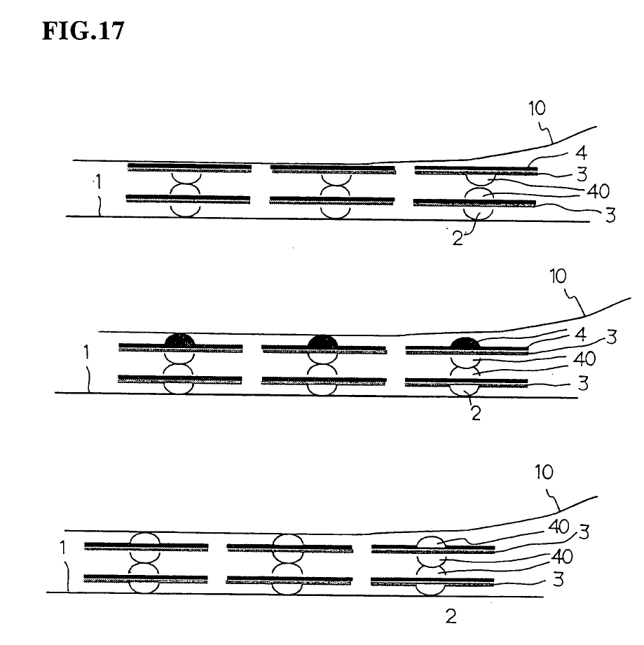

After drying the lower decorative portion and the upper decorative portion, the lower decorative portion and the upper decorative portion are combined together via the adhesive layers 40 as shown in FIG. 17. After combined, the sheet 10 is removed so as to obtain the sheet 1 with a decorative article comprising the multi-layered decorative layers. In FIG. 15 and FIG. 17, each view corresponds to each other.

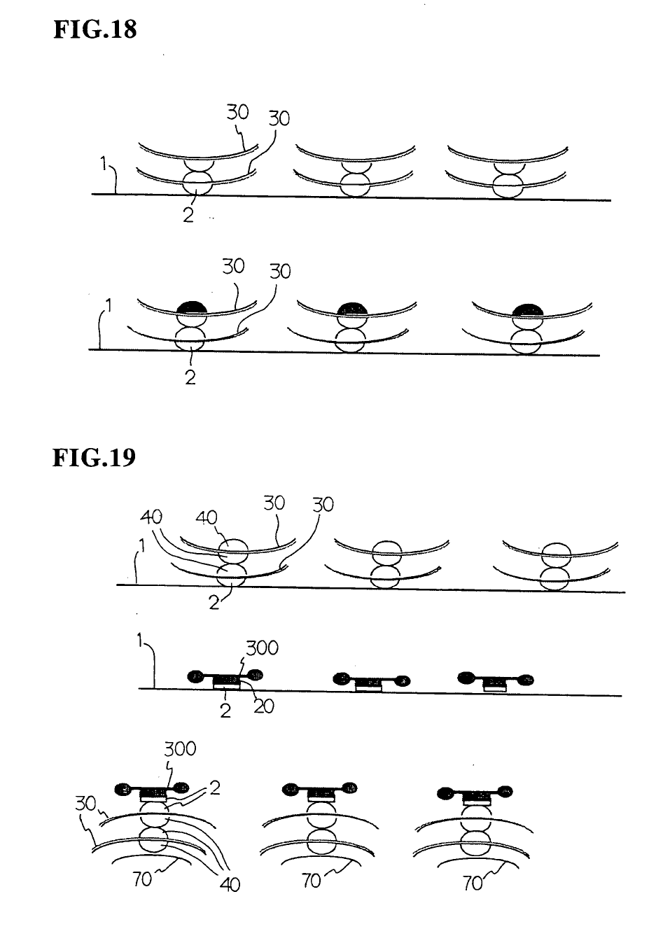

By heating the multi-layered decorative layers, each layer is deformed. Before heating, each layer may be in contact to each other but may be independently deformed. An upper view of FIG. 18 corresponds to an upper view of FIG. 17 and a lower view of FIG. 18 corresponds to a middle view of FIG. 17.

An upper view of FIG. 19 corresponds to a lower view of FIG. 17. FIG. 19 shows an embodiment of multi-layered decorative articles that is similar to the embodiment of FIG. 13 and FIG. 14. FIGS. 15 through 19 show a decorative article of two layers but a decorative article of three or more layers can be obtained by repeating the same process.

While the preferred embodiment of the invention has been illustrated and described, it will be appreciated that various changes can be made therein without departing from the spirit and scope of the invention.

1. A method of making a sheet with one or more removable decorative articles thereon, said method comprising the steps of:
(a) providing a sheet having at least one release surface;
(b) providing an adhesive layer on the release surface of the sheet;
(c) providing one or more decorative layers on the adhesive layer, the one or more decorative layers having one or more adhesive-free portions being free of the adhesive layer, at least one of said one or more adhesive-free portions being in contact with the release surface of the release sheet, the one or more decorative layers comprising a foaming agent; and
(d) heating the one or more decorative layers to release said one or more adhesive-free portions being in contact with the release surface from the release surface and to deform the one or more adhesive-free portions to apply a three-dimensional appearance thereto, thereby obtaining the sheet provided with one or more decorative articles comprising the one or more decorative layers and the adhesive layer, and the one or more decorative articles removably mounted on the release surface of the sheet.

2. The method of claim 1, wherein at least one of said decorative layers has an area larger than an area of the adhesive layer.

3. The method of claim 1, wherein the one or more adhesive-free portions include one or more free ends.

4. The method of claim 1, wherein each of said layers is formed by silk screen printing.

5. The method of claim 4, wherein the one or more decorative layers are formed by a plurality of silk screen printing processes.

6. The method of claim 4, wherein said providing one or more decorative layers comprises applying a printing paste on the adhesive layer, and wherein the printing paste comprises a foaming agent and a waterborne resin.

7. The method of claim 6, wherein the waterborne resin is selected from the group consisting of urethane resin, acrylic resin, urethane-acrylic resin, silicone resin and any combinations thereof.

8. The method of claim 1, wherein the adhesive layer comprises a pressure-sensitive adhesive.

9. The method of claim 1, wherein the deformation is warping or bowing.

10. The method of claim 1, further comprising the step of providing a top layer on the one or more decorative layers prior to or after the heat treatment.

11. The method of claim 1, further comprising the steps of providing another adhesive layer on the one or more decorative layers prior to or after the heat treatment.

12. The method of claim 3, wherein the one or more decorative layers have one or more slits or openings therein, and wherein the one or more adhesive-free portions comprise one or more portions in the vicinity of edges defining the slits.

13. A method of making a sheet with one or more removable decorative articles thereon, said method comprising the steps of:
(a) providing a sheet having at least one release surface;
(b) providing an adhesive layer on the release surface of the sheet;
(c) providing a buffer layer on the adhesive layer, the buffer layer overlaying an entire surface of the adhesive layer;
(d) providing one or more decorative layer on the buffer layer, the one or more decorative layer having one or more adhesive-free portions being free of the adhesive layer, at least one of said one or more adhesive-free portions being in contact with the release surface of the release sheet, the one or more decorative layers comprising a foaming agent; and
(e) heating the one or more decorative layer to release said one or more adhesive-free portions being in contact with the release surface from the release surface of the sheet and to deform the adhesive-free portions to apply a three-dimensional appearance thereto, thereby obtaining the sheet provided with one or more decorative articles comprising the one or more decorative layers, the buffer layer and adhesive layer, and the one or more decorative articles removably mounted on the release surface of the sheet.

14. The method of claim 13, wherein at least one of said decorative layers has an area larger than an area of the adhesive layer and an area of the buffer layer.

15. The method of claim 13, wherein the one or more adhesive-free portions include one or more free ends.

16. The method of claim 13, wherein each of said layers is formed by silk screen printing.

17. The method of claim 16, wherein the one or more decorative layer are formed by a plurality of silk screen printing processes.

18. The method of claim 16, wherein said providing a buffer layer comprises applying a first printing paste on the adhesive layer, wherein said providing one or more decorative layers comprises applying a second printing paste on the buffer layer, and wherein a viscosity of the first printing paste is smaller than a viscosity of the second printing paste.

19. The method of claim 18, wherein the first and second printing pastes comprise a waterborne resin.

20. The method of claim 19, wherein the waterborne resin is selected from the group consisting of urethane resin, acrylic resin, urethane-acrylic resin, silicone resin and any combinations thereof.

21. The method of claim 13, wherein the adhesive layer comprises a pressure-sensitive adhesive.

22. The method of claim 13, wherein the deformation is warping or bowing.

23. The method of claim 13, further comprising the step of providing a top layer on the one or more decorative layers prior to or after the heat treatment.

24. The method of claim 13, further comprising the steps of providing another adhesive layer on the one or more decorative layers prior to or after the heat treatment.

25. The method of claim 16, wherein the one or more decorative layers have one or more slits or openings therein, and wherein the one or more adhesive-free portions comprise one or more portions in the vicinity of edges defining the slits.

26. A sheet with one or more removable decorative articles thereon, the decorative article comprising an adhesive layer and one or more decorative layers, said sheet comprising:
(a) a sheet having at least one release surface;
(b) an adhesive layer formed on the release surface of the sheet; and
(c) one or more decorative layers formed on the adhesive layer, the one or more decorative layers having one or more adhesive-free portions being free of the adhesive layer; wherein at least one or more portions of the one or more decorative layers are formed from a material comprising a foaming agent, the one or more adhesive-free portions are three-dimensionally deformed by heat treatment, and the one or more decorative articles removably mounted on the release surface of the sheet.

27. The sheet of claim 26, wherein at least one of said decorative layers has an area larger than an area of the adhesive layer.

28. The sheet of claim 26, the one or more decorative articles further comprising a buffer layer provided between the adhesive layer and the decorative layer, and the buffer layer having an area substantially equal to or larger than the area of the adhesive layer.

29. The sheet of claim 26, wherein said one or more decorative layers comprise a material of urethane resin, acrylic resin, urethane-acrylic resin, silicone resin and any combinations thereof.

30. The sheet of claim 26, wherein a top layer is provided on said one or more decorative layers.

31. The sheet of claim 26, wherein another adhesive layer is provided on said one or more decorative layers.
